(19) United States
(12) Patent Application Publication
(10) Pub. No.: US 2006/0089881 A1
(43) Pub. Date: Apr. 27, 2006

(54) Retail restaurant business

(76) Inventor: Michael W. Landry, San Diego, CA (US)

Correspondence Address: MICHAEL W LANDRY, 5098 SEACHASE STREET, SAN DIEGO, CA, 92130, US

(21) Appl. No.: 11/256,760

(22) Filed: Oct. 24, 2005

Related U.S. Application Data
(60) Provisional application No. 60/622,091, filed on Oct. 26, 2004.

(51) Int. Cl. G06Q 30/00

(52) U.S. Cl. 705/15

(57) ABSTRACT

In a retail food establishment, substantially all the food items on the menu are identified with their respective trademarks. Menus displayed on a board and printed menus handed to customers both make use of trademarks identifying the food items. Trademarks can be graphic logos or simple text.

### RELATED APPLICATIONS

This application claims priority to United States provisional application number 60/622,091, entitled “Retail Restaurant Business”, filed Oct. 26, 2004, incorporated herein by reference.

### BACKGROUND

### Field of the Invention

The present invention relates to retail food businesses.

### Prior Art

The use of trademarks to identify consumer products is well known, specifically for food items purchased for home consumption. Retail food restaurants selectively use trademarks to identify certain of the items on the menu. Trademarks are commonly used to identify beverages, for example Coca-Cola® soft drink, alcoholic drinks, for example Coors beer and Baileys Irish Cream liquor. Commodity food items, such as potatoes, meats, and vegetables are generally not identified in a way that the source of the item is known.

Trademarks serve the purpose of identifying goods and services, but are also described as source identifying, that is, the trademark becomes associated with a particular source of supply of the good or service, even if that source is unknown. The use of trademarks facilitates an efficient market place. The consumer, once having recognized a product as satisfactory, can continue to purchase that product by referring to its identification through the trademark that the supplier uses.

In prior art retail food restaurant businesses, trademarks are not fully utilized to facilitate an efficient transaction and enhance the level of sales.

### SUMMARY OF THE INVENTION

In a retail food establishment, substantially all the food items on the menu are identified with their respective trademarks. The food items are purchased by the food establishment from an authorized supplier and the trademarks are used with permission of the owners. In some cases, the trademark owners pay, in the form of incentives, discounts, or cash, to have their food items displayed on the menu and sold.

Menus displayed on a board and printed menus handed to customers both make use of trademarks identifying the food items. Substantially all the food items offered for sale are identified with trademarks. A menu can have a description of the food items along with the trademarks. Trademarks can be graphic logos or simple text.

A food business operated according to the present invention provides benefits to the customer by allowing the customer to recognize the food item being purchased and receive an expected level of quality in the food item that is controlled by the trademark owner. The product identifying and source identifying characteristics of trademarks are used to increase the efficiency of consumer selection during a purchase transaction.

The present invention can be applied to a fast food restaurant or to a sit-down restaurant.

### BRIEF DESCRIPTION OF THE DRAWINGS

FIGS. 1A and 1B show pages of an example menu according to the present invention.

### DETAILED DESCRIPTION OF THE INVENTION

According to the present invention, a retail restaurant business uses trademarked names to identify substantially all the food items sold by the business. The printed and displayed menus use the trademark of the food items next to or near each menu listing. Trademarks are words or graphic images. In one embodiment, menus use sections grouped by food type with each section heading showing trademarks graphically, in text, or both. Optionally, additional trademarks appear next to each menu listing. Where a menu item uses ingredients from more than one source, the trademarks of each major ingredient can be listed with the menu item. For example, a peanut butter and jelly sandwich could list Skippy peanut butter, Smuckers preserves, and Milton's bread.

All trademark instances would preferably use the proper form, namely the trademark as a proper adjective that modifies the generic name for the food item. Appropriate use of the registered trademark symbol “®” or unregistered trademark symbol ‘™’ are preferably used.

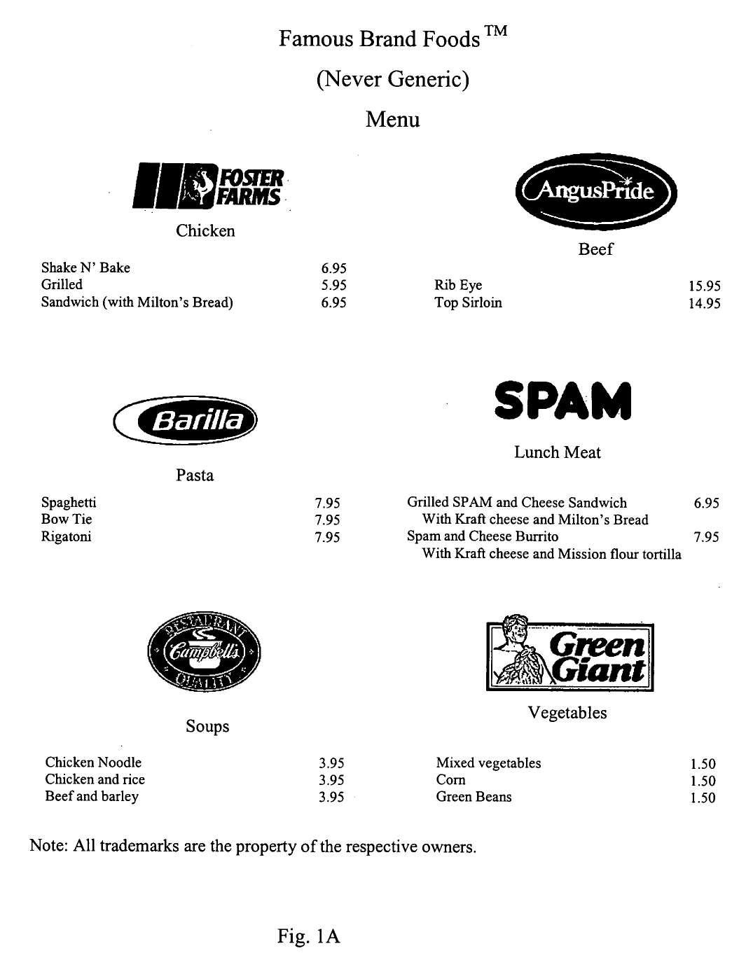

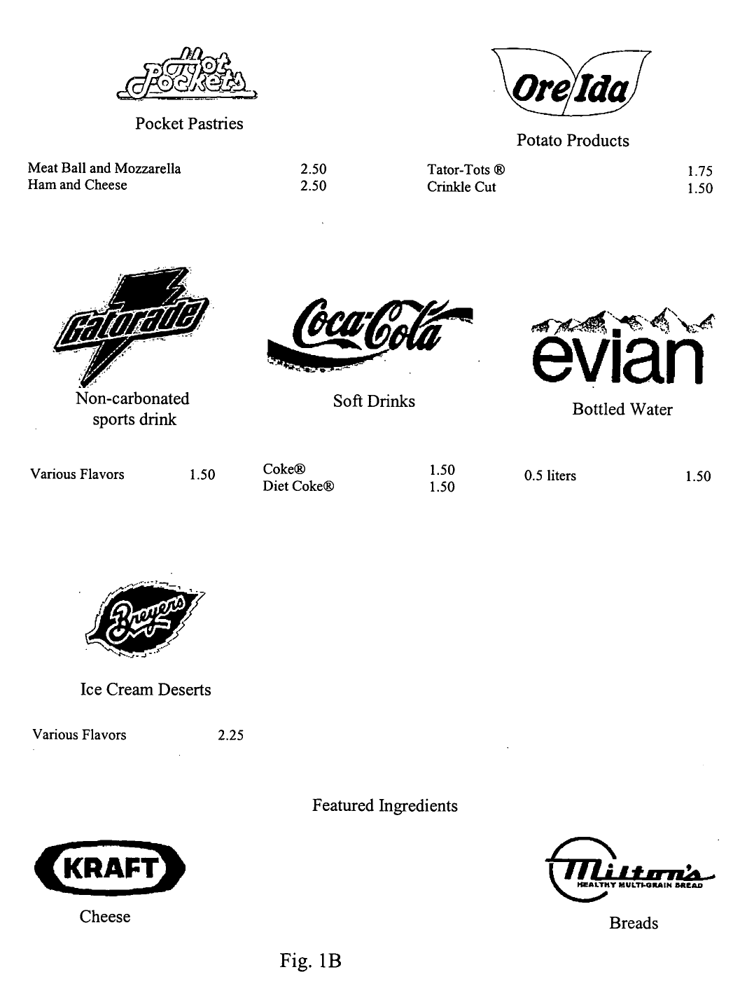

FIG. 1 shows an example of a menu according to the present invention. Each menu section has a trademark included in the heading. Items in each section can include combinations with other trademarked items and non-trademarked items. The menu format provides for efficient location of desired food selections.

The choice of trademark items for the menu can be changed over time, with one trademarked item replacing another. The change can be based on cost of supply or as food tastes and trends change. Additionally, changes to the menu can be made on an occasional or periodic basis. Regional variations are also expected.

The retail restaurant business according to the present invention can be operated as a franchise network or as company owned stores or a mix of both. In either case, the name of the restaurant would itself be a trademark.

One aspect of the invention is that it supports advertising of the menu items. The presentation of the names and logos of the trademarked products combined with a positive eating experience can enhance the product's brand image in the mind of the consumer. Product manufacturers and distributors, as owners of the trademarks or acting as agents of the trademark owners, are likely interested in paying for the value of the advertising, that is, promotional consideration. Payment can take the form of direct money payments or product discounts offered to the restaurant.

In another embodiment of the present invention, non-food items to which the customer is exposed are also brand name products. Examples include plastic ware, metal ware, napkins, and even items not related to serving food such as bathroom soap, toilet paper, paper towels, and furniture.

An optional certification process can be implemented by the retail food business where trademark owners can receive assurance that food preparation is being performed in accordance with the trademark owner's quality standards. Food preparation specifications can be provided by the trademark owner and the food business can undertake audits of the business to insure compliance.

The principle of the present invention can be extended beyond food businesses. A retail business can created a line of products for sale by performing the steps of selecting products types to offer for sale; identify at least one source for each product type that has a trademark associated with the product type; select from the identified sources for each product type a single trademarked product; and include the selected trademarked product in the line of products; then offer the line of products for sale to retail customers.

What is claimed is:

1. A method of operating a retail food business comprising:
preparing a menu listing food items wherein substantially all the food items are identified by trademarks on the menu;
and presenting the menu to customers wherein the trademarks are visible along with each listed food item.

2. The method of claim 1 wherein the step of preparing a menu listing food items further comprises the step of including on the menu major ingredients of food items wherein substantially all the major ingredients of food items are identified by trademarks;

3. The method of claim 1 further comprising a transaction wherein owners of at least some of the trademarks pay the food business to place the trademark owner's products on the menu.

4. The method of claim 1 further comprising a certification process wherein trademark owners can receive assurance that food preparation is being performed in accordance with the trademark owner's quality standards.

5. The method of claim 1 further comprising the step of prominently displaying trademarks for non-food items used in conjunction with serving food.

6. The method of claim 1 wherein the step of preparing a menu listing food items further comprises the step of including on the menu primary ingredients of food items wherein substantially all the primary ingredients of food items are identified by trademarks;
and the method further comprises a transaction wherein an owner of at least one of the trademarks pays the food business to place the trademark owner's products on the menu;
a certification process wherein trademark owners can receive assurance that food preparation is being performed in accordance with the trademark owner's quality standards; and
prominently displaying trademarks for non-food items used in conjunction with serving food.

7. A menu for a retail food business comprising:
a listing of food items wherein substantially all the food items are identified with a trademark.

8. The menu of claim 7 wherein the trademarks are shown graphically.

9. The menu of claim 7 wherein the trademarks are shown as text.

10. The menu of claim 7 comprising a plurality of menu sections with each menu section headed by a trademark graphic symbol.

11. The menu of claim 10 wherein the menu sections include chicken, beef, pasta, soup, vegetable, potato, soft drinks, and dessert.

12. The menu of claim 7 wherein substantially all major ingredients of food items are identified with trademarks.

13. A method of operating a retail food business comprising the steps of:
creating a menu of food items;
using sources of supply for food items on the menu wherein substantially all the supplied food items are associated with trademarks; and
displaying to customers the trademarks of the food items on the menu.

14. The method of claim 13 further comprising a certification process wherein trademark owners can receive assurance that food preparation is being performed in accordance with the trademark owner's quality standards.

15. The method of claim 13 wherein the menu comprises a plurality of menu sections with each menu section headed by a trademark graphic symbol.

16. The method of claim 13 further comprising the step of prominently displaying trademarks for non-food items used in conjunction with serving food.

17. The method of claim 13 further comprising the step of certifying that food preparation process is in accordance with requirements of respective food suppliers.

18. The method of claim 13 further comprising the step of receiving promotional consideration from the food suppliers in exchange for placement of trademarked products on the menu.
